(19) United States
(12) Patent Application Publication
(10) Pub. No.: US 2006/0060631 A1
(43) Pub. Date: Mar. 23, 2006

(54) Motion control device for wire bonder bondhead

(75) Inventors: E. Walter Frasch, Perkasie, PA (US); David T. Beatson, Kennett Square, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Kulicke and Soffa Industries, Inc.

(21) Appl. No.: 11/230,767

(22) Filed: Sep. 20, 2005

Related U.S. Application Data
(60) Provisional application No. 60/611,954, filed on Sep. 22, 2004.

(51) Int. Cl. B23K 37/00

(52) U.S. Cl. 228/4.5

(57) ABSTRACT

A motion control device for controlling rotary and linear motion which includes a first linear actuator having a first fixed member and a first moveable drive member, the first moveable drive member being driven for motion relative to the first fixed member along a first longitudinal axis. The device also includes a second linear actuator having a second fixed member and a second moveable drive member, the second movable drive member being driven for motion relative to the second fixed member along a second longitudinal axis. A drive assembly is configured to be driven by the first and second moveable drive members for (a) linear motion along an axis substantially parallel to the first and second longitudinal axes, and (b) rotation about an axis of rotation. A position of each of the moveable drive members is separately controllable to control rotational and linear positions of the drive assembly.

### RELATED APPLICATION

This application is related to and claims priority from U.S. Provisional Application Ser. No. 60/611954, filed Sep. 22, 2004, which is incorporated herein by reference in its entirety.

### FIELD OF THE INVENTION

The present invention relates to the field of precision motion control devices generally and, more particularly, to motion control devices which are particularly well-suited for use with a wire bonder machine to provide high speed linear and rotational movement of a bonding head.

### BACKGROUND OF THE INVENTION

Wire bonders (aka wire bonder machines, wire bonding machines, etc.) are known in the prior art. Wire bonders are used in semiconductor manufacturing to attach semiconductor dies directly to a circuit board substrate. Automatic wire bonders have been developed which utilize stored position data to control the bonding operation. Certain wire bonders, such as the Maxμm™ IC Ball Bonder sold by Kulicke and Soffa Industries, Inc., Willow Grove, Pa., use a vertically displaceable wire bonding head along with a horizontally translatable semiconductor work table. In this conventional wire bonder, three high speed motors (one associated with movement in each of the three spatial dimensions) are used to position the semiconductor device and bonding tool at the appropriate locations.

Another example of a wire bonder is disclosed in U.S. Pat. No. 6,460,751 (Thurlemann). Thurlemann discloses a bondhead drive mechanism including two linear motors, 12 and 14. First linear motor 12 drives the bondhead for providing translational, linear motion, while second linear motor 14 drives rotary beam 4 portion of the bondhead for rotary movement. Thus, movement of a bonding tool or capillary 7 is controlled for both translation and rotation by linear motors 12 and 14. Thurlemann discloses two linear motors 12, 14 having movable coils 11 and 15, respectively, which move along axes of motion which are perpendicular to one another.

One way to reduce the costs associated with the manufacture of a semiconductor product is to increase the speed of operation of the bonding machine thereby increasing the number of units produced per hour. Speed of operation is typically limited by a combination of the weight and weight distribution of moving components and the corresponding amount of force used to rapidly accelerate and decelerate the moving components.

Thus, it would be desirable to provide an improved motion control device with a well-balanced, compact design which is suitable for use in a wire bonder machine and which provides high speed bonding.

### SUMMARY OF THE INVENTION

According to an exemplary embodiment of the present invention, a motion control device for controlling rotary and linear motion is provided. The motion control device includes a first linear actuator having a first fixed member and a first moveable drive member, the first moveable drive member being driven for motion relative to the first fixed member along a first longitudinal axis. The motion control device also includes a second linear actuator having a second fixed member and a second moveable drive member, the second movable drive member being driven for motion relative to the second fixed member along a second longitudinal axis. The motion control device also includes a drive assembly, the drive assembly being configured to be driven by the first moveable drive member and the second moveable drive member for (a) linear motion along a first axis substantially parallel to the first longitudinal axis and the second longitudinal axis, and (b) rotation about an axis of rotation. A position of each of the first moveable drive member and the second moveable drive member is separately controllable to control rotational and linear positions of the drive assembly.

According to another exemplary embodiment of the present invention, a wire bonding machine is provided. The wire bonding machine includes a work table for supporting at least one semiconductor device to be wire bonded, a conveyance system for translating the work table in a substantially horizontal direction, a wire bonding head assembly including a bonding tool, and a motion control device for controlling rotary and linear motion. The motion control device includes a first linear actuator having a first fixed member and a first moveable drive member, the first moveable drive member being driven for motion relative to the first fixed member along a first longitudinal axis. The motion control device also includes a second linear actuator having a second fixed member and a second moveable drive member, the second movable drive member being driven for motion relative to the second fixed member along a second longitudinal axis. The motion control device also includes a drive assembly, the drive assembly being configured to be driven by the first moveable drive member and the second moveable drive member for (a) linear motion along a first axis substantially parallel to the first longitudinal axis and the second longitudinal axis, and (b) rotation about an axis of rotation. A position of each of the first moveable drive member and the second moveable drive member is separately controllable to control rotational and linear positions of the drive assembly.

The foregoing and other features of presently preferred embodiments of the invention and advantages of the presently preferred embodiments will become more apparent in light of the following detailed description, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show presently preferred embodiments of the invention. However, it should be understood that this invention is not limited to the precise arrangements and instrumentalities shown in the drawings.

FIG. 1 is a front perspective view of a motion control device shown incorporated into a portion of a wire bonding machine in accordance with an exemplary embodiment of the present invention.

FIG. 2 is a side perspective view of the motion control device, bonding head, and work table of FIG. 1.

FIG. 3 is a top plan view of the motion control device, wire bonding head, and work table of FIG. 1.

FIG. 4 is a side perspective view of another motion control device shown incorporated into a portion of a wire bonding machine in accordance with an exemplary embodiment of the present invention.

FIG. 5A is a side perspective view of another motion control device shown incorporated into a portion of a wire bonding machine in accordance with an exemplary embodiment of the present invention.

FIG. 5B is a top plan view of the motion control device of FIG. 5A, with the bonding head shown in a centered position.

FIG. 5C is a top plan view of the motion control device of FIG. 5A, with the bonding head shown in an offset position.

### DETAILED DESCRIPTION OF THE PREFERRED EMBODIMENTS

The present invention relates to motion control devices for controlling rotary and linear motion. According to certain exemplary embodiments of the present invention, a motion control device includes first and second linear actuators coupled to a drive assembly. The linear actuators are arranged to extend along substantially parallel longitudinal axes and are separately controllable to control linear and rotational motion of the drive assembly. For example, the linear actuators may be voice coil motors or linear servomotors. Other exemplary types of motors include multiphase, ironcore, ironless or magnetic rod linear motors. The motion control device may be incorporated into a wire bonding machine.

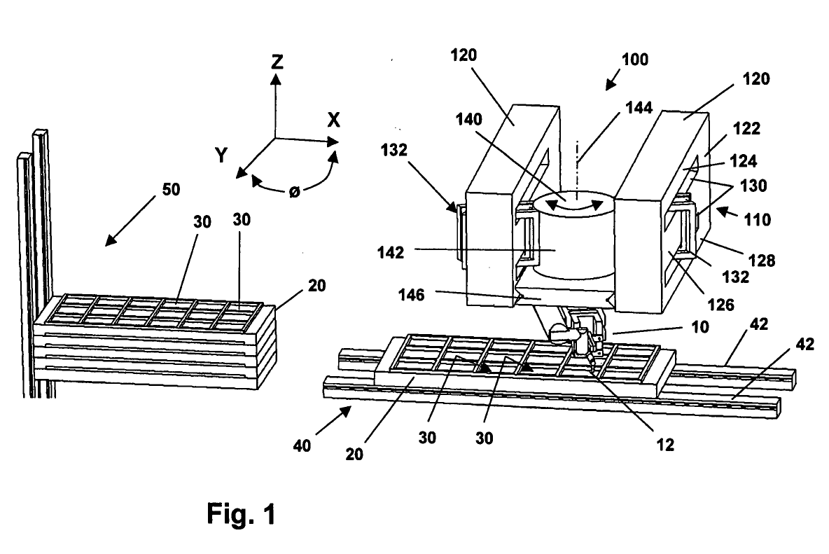

Referring now to the drawings, wherein like reference numerals illustrate corresponding or similar elements throughout the several views, FIG. 1 is a perspective view of a portion of a wire bonding machine having wire bonder head assembly 10 and motion control device 100 according to an exemplary embodiment of the present invention. The wire bonding machine preferably includes wire bonder head assembly 10, work table 20 supporting workpiece 30, conveyance system 40, and magazine handler 50. Wire bonder head assembly 10 includes bonding tool 12 (e.g., capillary tool 12) for dispensing and/or channeling a wire (not shown) to workpiece 30. Wire bonder head assembly 10 is driven for translation and rotation by drive assembly 140. Many of the detailed features of wire bonder head assembly 10 are conventional in the art and the details of which are not necessary for an understanding of the present invention. As such, no discussion is provided in this application. Similarly, many of the aspects of the wire bonding machine and its operation are conventional and, therefore, are also not described herein. Those skilled in the art are familiar with the general construction and arrangement of such components, and would be readily capable of applying the teachings provided herein to such machines.

To facilitate the description of the presently preferred embodiments, it will be useful to define a coordinate system as a point of reference for certain spatial relationships and/or displacements. As indicated in the various figures, an X-Y plane corresponds to a “horizontal” plane while X-Z and Y-Z planes correspond to “vertical” planes. The X axis corresponds to a direction of travel of workpiece 30. The Y axis corresponds to a direction of translation of drive assembly 140. The Z axis corresponds to the “vertical” direction. Rotational motion of drive assembly 140 in the X-Y plane occurs through an angular displacement ø.

Wire bonder head assembly 10 is positioned above indexing conveyance system 40, which, as in the illustrated embodiment, may include conventional set of guide rails 42 and a motor drive (not shown) for translating workpiece 30 (e.g., a semiconductor device) relative to bonding tool 12. Any conventional wire bonding conveyance system may be used in the present invention. More particularly, workpiece 30 is mounted on work table 20 which holds one or more workpieces 30. Work table 20 (or magazine) may be supplied to indexing conveyance system 40 by magazine handler 50.

Wire bonder head assembly 10 may be mounted to the bonding machine through a conventional attachment which permits bonding tool 12 to move vertically (i.e., in the Z direction) relative to workpiece 30. U.S. Pat. No. 4,266,710, the disclosure of which is incorporated herein by reference in its entirety, describes one type of mounting arrangement that could be used in the present invention. The mounting arrangement may include a pivot or hinge mount which permits bonding tool 12 to move up and down in the Z direction (toward and away from workpiece 30) so as to permit the bonding of the wires to the semiconductor device at various vertical positions. Those skilled in the art are familiar with such mounting arrangements as well as other mechanisms for vertical positioning of a bonding tool and, therefore, no further discussion is needed. The present invention can be readily incorporated into many conventional wire bonders, such as Kulicke and Soffa's 8028 Ball Bonder or Maxμm™ IC Ball Bonder.

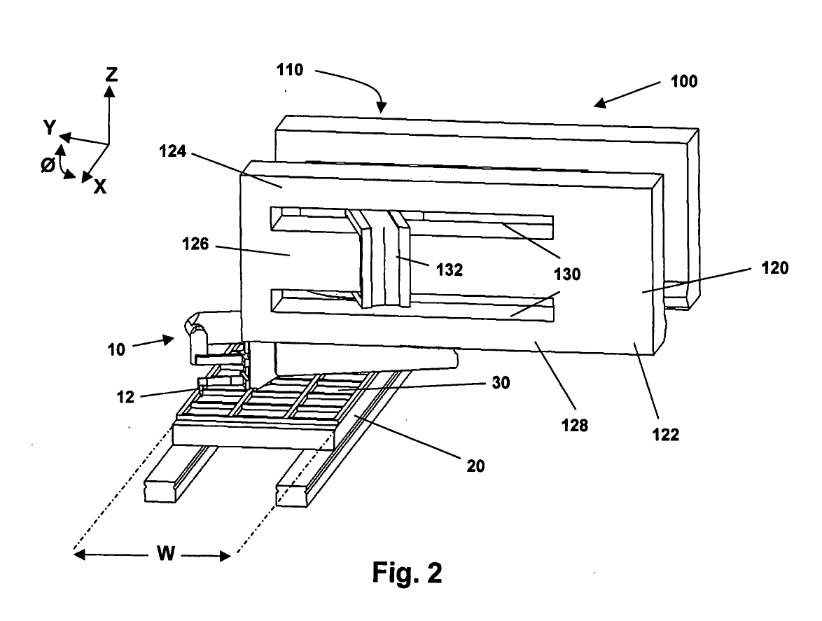

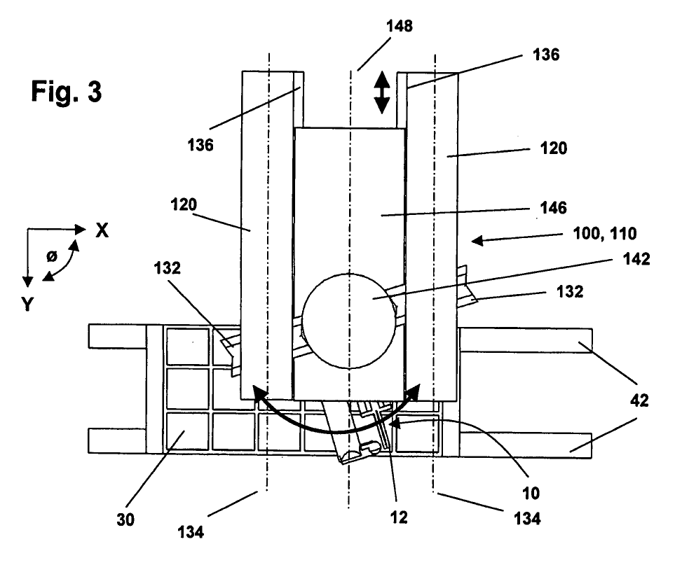

With reference now to FIGS. 1-3, motion control device 100 comprises first and second linear actuators each having a fixed member (or stator) and a movable drive member. Exemplary linear actuator assembly 110 includes first and second linear voice coil actuators 120 and voice coils 132. The artisan will recognize that in order to be operative, linear voice coil actuators 120 are typically engaged with various additional components, including, for example, a controller (not shown), a power source (not shown), position sensors (not shown), etc. Each linear voice coil actuator 120 includes a fixed member magnetic circuit assembly (e.g., yoke 122) configured with a movable drive member (e.g., moving voice coil 132). The movement of each moving coil 132 is capable of being separately controllable. Yoke 122 includes upper portion 124, central portion 126, and lower portion 128, producing the permanent magnetic field for voice coil motor 120. Openings 130 are defined between the lower and central portions and the upper and central portions, respectively. Moving coil 132 moves within openings 130. In general, each movable drive member is driven for motion relative to the fixed member along a longitudinal axis of motion. More particularly, relative to linear actuator assembly 110, each moving coil 132 moves relative to a respective yoke member 122 along a longitudinal axis of motion 134. The illustrated exemplary longitudinal axes of motion 134 are substantially parallel to one another.

Each moving coil 132 is coupled to drive head portion 142 of drive assembly 140. Drive assembly 140 includes drive head 142, which is rotatably coupled with platform 146. Drive head 142 rotates about axis of rotation 144. Wire bonder head assembly 10 is preferably disposed beneath platform 146, opposite drive head 142. Drive head 142 is coupled to wire bonder head assembly 10 such that wire bonder head assembly 10 rotates with drive head 142. Platform 146 translates with drive head 142 and wire bonder head assembly 10 along first axis 148 on rails 136 formed in yokes 122. First axis 148 may be, for example, substantially parallel to the longitudinal axes of motion 134. Further, first axis 148 may be, for example, substantially perpendicular to axis of rotation 144.

The travel of moving coils 132 is chosen to allow a range of linear motion of bonding tool 12 at least across the entire width W of workpiece 30. Moving coils 132 are sized relative to central portion 126 of yoke 122 to allow moving coils 132 to be rotated, for example, approximately plus or minus 30 degrees about axis of rotation 144 over the entire range of linear translation of bonding tool 12 along the Y axis. Of course, different ranges of linear motion and rotative motion (e.g., larger ranges of motion, smaller ranges of motion) are contemplated.

In operation, drive head 142 is driven by moving coils 132 for translation along first axis 148 and for rotation about axis of rotation 144. For example, by controlling both of moving coils 132 to move in the same amount and in the same direction along the longitudinal axes of motion 134, drive head 142, platform 146, and wire bonder head assembly 10 are all translated in the Y direction along first axis 148. If, however, the moving coils 132 are moved in different directions or in the same direction by different amounts along the longitudinal axes of motion 134, drive head 142, and wire bonder head assembly 10 are rotated relative to platform 146.

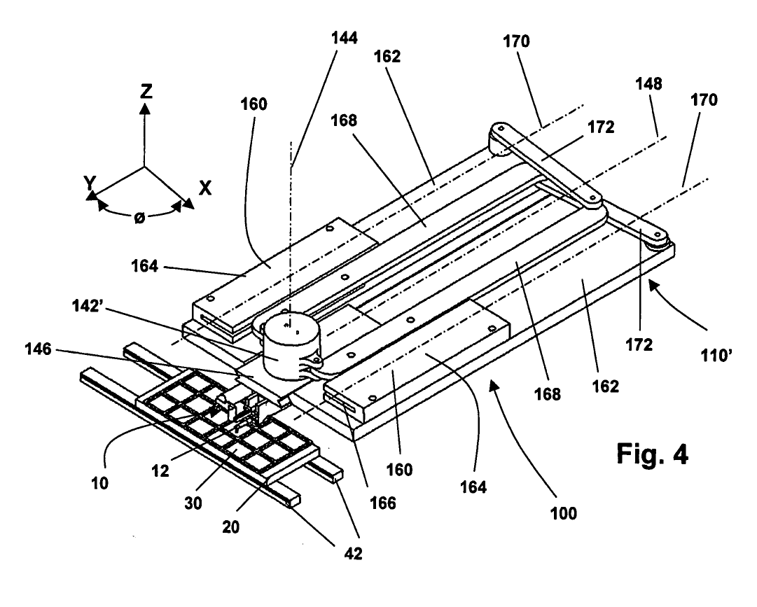

With particular reference now to FIG. 4, another exemplary embodiment includes linear actuator assembly 110′, with the linear actuators being linear servomotors 160. In particular, linear servomotors 160 may be, for example, a rare-earth magnet, brushless linear servomotor, available from, many sources such as Aerotech, Inc., Pittsburgh, Pa. First and second linear servomotors 160 are provided and each comprises a fixed member, in particular a U-shaped channel housing 164 which is mounted to a frame member 162. Those skilled in the art will recognize that linear servomotors 160 may be operatively coupled with additional components including, for example, a controller (not shown), a power source (not shown), and position sensors (not shown). Each linear servomotor 160 further comprises a movable drive member (not clearly visible in FIG. 4) which moves along longitudinal axis of motion 170 within magnet track 166. Longitudinal axes of motion 170 may be, for example, substantially parallel to one another. Each drive member is coupled to a drive link 168. At a first end, drive links 168 are each pivotally connected to drive head 142′. At a second end, drive links 168 are each connected to pivot link 172.

Drive head 142′ functions in a manner similar to drive head 142 illustrated and described with reference to FIGS. 1-3. That is, drive head 142′ is rotatably coupled with platform 146, and rotates about axis of rotation 144. As with linear actuator assembly 110 (illustrated in FIGS. 1-3), linear actuator assembly 110′ is configured with wire bonder head assembly 10 disposed beneath platform 146 for rotation with drive head 142′. Platform 146 is supported for translation along the Y axis by rails formed by interior edges of frame members 162.

The travel of drive links 168 is chosen to allow a range of linear motion of bonding tool 12 at least across the entire width W of workpiece 30 and to further allow a range of rotational motion of approximately, for example, plus or minus 30 degrees throughout the range of linear motion. Of course, different ranges of linear motion and rotative motion (e.g., larger ranges of motion, smaller ranges of motion) are contemplated.

In operation, the movement of each drive link 168 is capable of being separately controllable. Drive head 142′ is driven by drive links 168 for translation along first axis 148 and for rotation about axis of rotation 144. For example, by controlling both drive links 168 to move in the same amount and in the same direction along the longitudinal axes of motion 170, drive head 142′, platform 146, and wire bonder head assembly 10 are all translated in the Y direction along first axis 148. If, however, drive links 168 are moved in different directions or in the same direction by different amounts along longitudinal axes of motion 170, drive head 142′, and wire bonder head assembly 10 are rotated relative to the platform 146.

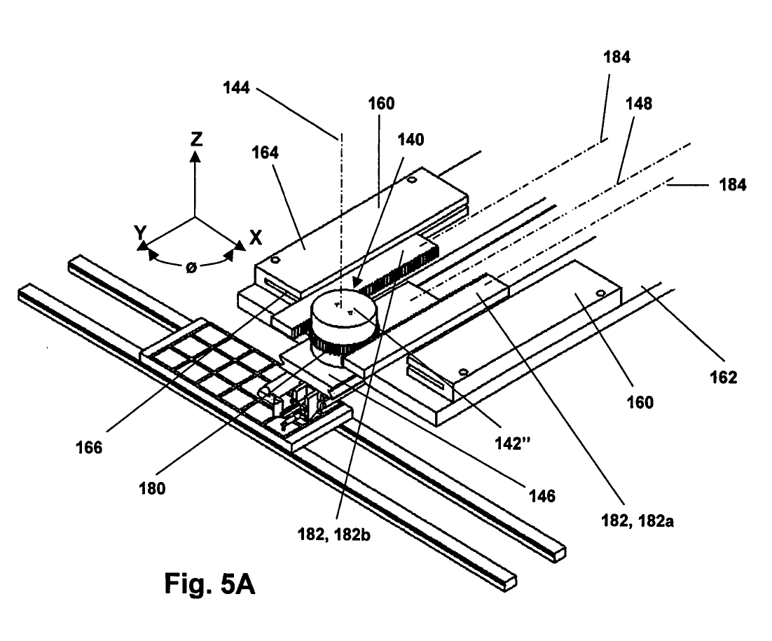

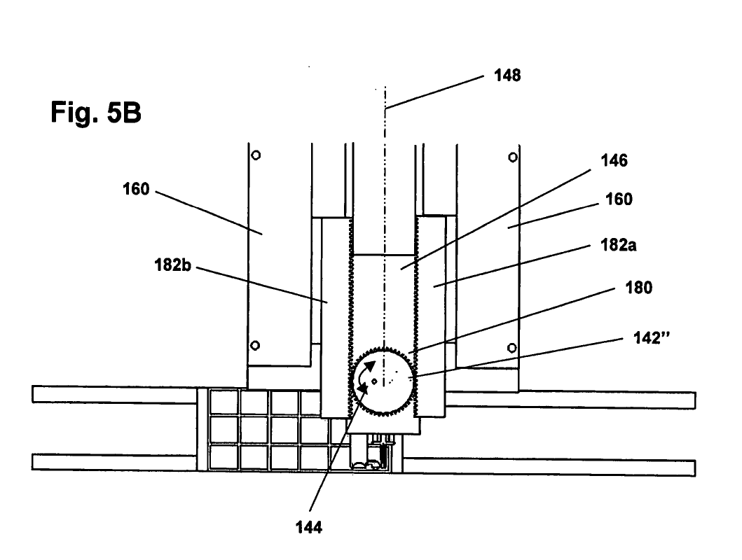

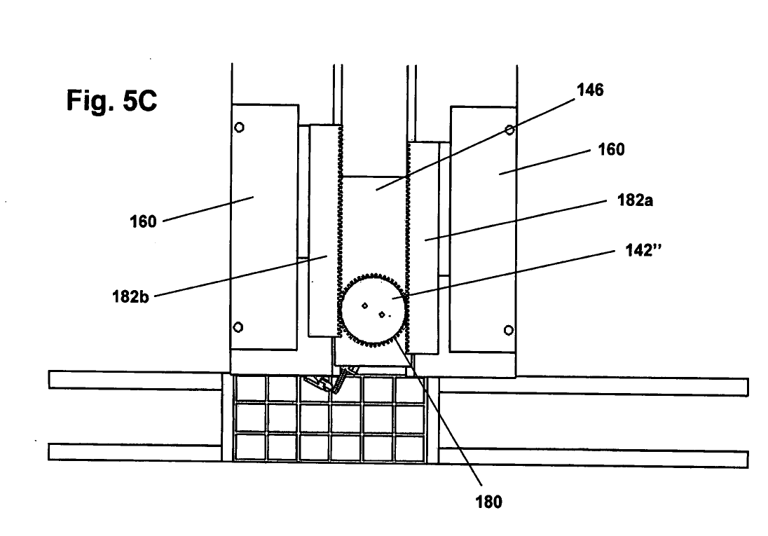

With particular reference now to FIGS. 5A-5C, an exemplary linear actuator assembly 110″ is illustrated where the linear actuators are linear servomotors 160 operably coupled with a pair of gear racks 182a and 182b, generally referred to as gear racks 182. Similarly to drive members 168, gear racks 182 each move along a longitudinal axis of motion 184 within magnet tracks 166. The longitudinal axes of motion 184 may be, for example, substantially parallel to one another. Gear racks 182 operatively engage drive head 142″. In particular, drive head 142″ is provided with pinion gear 180 with teeth that mesh with the teeth on racks 182.

Drive head 142″ functions in a manner similar to drive heads 142 and 142′ described above with respect to FIGS. 1-3 and FIG. 4 respectively. That is, drive head 142″ is rotatably coupled with platform 146, and rotates about axis of rotation 144. As with linear actuator assemblies 110 and 110′, linear actuator assembly 110″ is configured with wire bonder head assembly 10 disposed beneath platform 146 for rotation with drive head 142″. Platform 146 is supported for translation along the Y axis by rails formed by interior edges of frame members 162.

The travel of gear racks 182 is chosen to allow a range of linear motion of bonding tool 12 at least across the entire width W of the workpiece 30 and to further allow a range of rotational motion of approximately plus or minus 30 degrees throughout the range of linear motion. Of course, different ranges of linear motion and rotative motion (e.g., larger ranges of motion, smaller ranges of motion) are contemplated.

With particular reference now to FIGS. 5B and 5C, in operation, the movement of each gear rack 182 is capable of being separately controllable. Drive head 142″ is driven by gear racks 182 for translation along first axis 148 and for rotation about axis of rotation 144. For example, by controlling both gear racks 182 to move in the same amount and in the same direction along the longitudinal axes of motion 184, drive head 142″, platform 146 and wire bonder head assembly 10 are all translated in the Y direction along first axis 148. If, however, gear racks 182 are moved in different directions or in the same direction by different amounts along the longitudinal axes of motion 184, drive head 142″, and wire bonder head assembly 10 are rotated relative to platform 146.

Those skilled in the art will recognize that the linear motion in the Y direction and rotational motion in the ø direction of wire bonder head assembly 10 afforded by the exemplary linear actuator assemblies 110, 110′ and 110″ may be combined with other ranges of motion, for example, a linear motion in the X direction provided by conveyance system 40 and a motion predominately in the Z direction of bonding tool 12 to provide a desired range of motion of bonding tool 12 to successfully complete processing of workpiece 30.

It should be further recognized that angular movement of bonding tool 12 about Z axis of rotation 144 provides, in addition to positional change in the X direction, some positional change in the Y-direction as well. Thus, the programming which controls the movement of moving coils 132 or drive links 168 or gear racks 182 to properly position bonding tool 12 for bonding, may take into account both the translational and rotational motion of bonding tool 12.

A camera (not illustrated in any of the illustrated exemplary embodiments) for obtaining image data related to workpiece 30 could be provided. The camera could be used to obtain position data, such as X-Y location and orientation, of workpiece 30 and/or bonding locations on workpiece 30. The data from the camera may be fed to a microprocessor or similar controller for use in controlling wire bonder head assembly 10 and bonding tool 12. For example, a fixed line scan camera may be used. Such cameras and positioning systems are well known in the art and, therefore, no further discussion is needed.

As a further option, the wire bonder machine could be provided with multiple work tables, for example, two work tables 20 running in parallel lanes (not illustrated) on

separate sets of guide rails 42. Such a “double lane” arrangement would permit the course movement of workpiece 30 in, for example, lane 1, to be moved into bonding position while the bonding head is attaching wires on workpiece 30 in lane 2. Such an arrangement may speed up the manufacturing process by moving the parts in and out of the bondable area in parallel without stopping the process of attaching wires.

It will be appreciated that other types of devices such as multiphase ironcore, ironless or magnetic rod linear motors could be incorporated into a motion control device (e.g., motion control device 100), in addition to the illustrated linear voice coil actuator 130 and linear servomotor 160 disclosed herein.

From this disclosure, the artisan will recognize that the presently preferred embodiments are conducive to a very compact, relatively light-weight, and well-balanced design. It is expected that motion control device 100 and the exemplary linear actuator assemblies 110, 110′, and 110″ will be especially useful when incorporated into wire bonding machines as the assemblies 110, 110′, and 110″ are expected to permit higher operating speeds of such machines.

The present invention may be embodied in other specific forms without departing from the spirit or essential attributes thereof and, accordingly, reference should be made to the appended claims, rather than to the foregoing specification, as indicating the scope of the invention.

What is claimed is:

1. A motion control device for controlling rotary and linear motion, the motion control device comprising:
a first linear actuator having a first fixed member and a first moveable drive member, the first moveable drive member being driven for motion relative to the first fixed member along a first longitudinal axis;
a second linear actuator having a second fixed member and a second moveable drive member, the second movable drive member being driven for motion relative to the second fixed member along a second longitudinal axis; and
a drive assembly, the drive assembly being configured to be driven by the first moveable drive member and the second moveable drive member for (a) linear motion along a first axis substantially parallel to the first longitudinal axis and the second longitudinal axis, and (b) rotation about an axis of rotation,
a position of each of the first moveable drive member and the second moveable drive member being separately controllable to control rotational and linear positions of the drive assembly.

2. The motion control device of claim 1, wherein the axis of rotation is substantially perpendicular to the first axis.

3. The motion control device of claim 1, wherein the drive assembly further includes a platform member slidingly engaged with the first and second fixed members.

4. The motion control device of claim 1, wherein the first and second linear actuators comprise respective voice coil motors.

5. The motion control device of claim 1, wherein the first and second linear actuators comprise respective linear servomotors, and the first and second moveable drive members are operably coupled to the drive assembly via a linkage.

6. The motion control device of claim 1, wherein the first and second linear actuators comprise respective linear servomotors, and the first and second moveable drive members are operably coupled to the drive assembly via a rack and pinion gear system.

7. The motion control device of claim 1, wherein the drive assembly has a mass that is substantially balanced relative to the axis of rotation.

8. The motion control device of claim 1 configured for engagement with a wire bonding machine.

9. The motion control device of claim 8, the drive assembly being engaged with a wire bonding head assembly including a bonding tool.

10. The motion control device of claim 8, the wire bonding machine further comprising:
a work table for supporting at least one semiconductor device to be wire bonded; and
a conveyance system for translating the work table in a substantially horizontal direction and substantially perpendicular to the first axis.

11. The motion control device of claim 10 further comprising a second work table for supporting a second semiconductor device to be wire bonded and a second conveyance system for translating the second work table in a substantially horizontal direction and substantially perpendicular to the first axis.

12. The motion control device of claim 10 further comprising a camera directed toward the work table for receiving an image of the work table or the at least one semiconductor device.

13. A wire bonding machine comprising:
a work table for supporting at least one semiconductor device to be wire bonded;
a conveyance system for translating the work table in a substantially horizontal direction;
a wire bonding head assembly including a bonding tool; and
a motion control device for controlling rotary and linear motion of the wire bonding head assembly, the motion control device comprising:
(a) a first linear actuator having a first fixed member and a first moveable drive member, the first moveable drive member being driven for motion relative to the first fixed member along a first longitudinal axis;
(b) a second linear actuator having a second fixed member and a second moveable drive member, the second movable drive member being driven for motion relative to the second fixed member along a second longitudinal axis; and
(c) a drive assembly, the drive assembly being configured to be driven by the first moveable drive member and the second moveable drive member for (1) linear motion along a first axis substantially parallel to the first longitudinal axis and the second longitudinal axis, and (2) rotation about an axis of rotation,
a position of each of the first moveable drive member and the second moveable drive member being separately controllable to control rotational and linear positions of the drive assembly.

14. The wire bonding machine of claim 13, wherein the axis of rotation is substantially perpendicular to the first axis.

15. The wire bonding machine of claim 13, wherein the drive assembly further includes a platform member slidingly engaged with the first and second fixed members.

16. The wire bonding machine of claim 13, wherein the first and second linear actuators comprise respective voice coil motors.

17. The wire bonding machine of claim 13, wherein the first and second linear actuators comprise respective linear servomotors, and the first and second moveable drive members are operably coupled to the drive assembly via a linkage.

18. The wire bonding machine of claim 13, wherein the first and second linear actuators comprise respective linear servomotors, and the first and second moveable drive members are operably coupled to the drive assembly via a rack and pinion gear system.

19. The wire bonding machine of claim 13, wherein the drive assembly has a mass that is substantially balanced relative to the axis of rotation.

20. The motion control device of claim 13 further comprising a second work table for supporting a second semiconductor device to be wire bonded and a second conveyance system for translating the second work table in a substantially horizontal direction and substantially perpendicular to the first axis.

21. The motion control device of claim 13 further comprising a camera directed toward the work table for receiving an image of the work table or the at least one semiconductor device.
